(19) United States
(12) Patent Application Publication
(10) Pub. No.: US 2011/0261204 A1
(43) Pub. Date: Oct. 27, 2011

(54) REMOTE ACTIVATION OF IMAGERY IN NIGHT VISION GOGGLES

(75) Inventor: WILLIAM A. SMITH, Daleville, VA (US)

(73) Assignee: ITT MANUFACTURING ENTERPRISES, INC, Wilmington, DE (US)

(21) Appl. No.: 12/768,002

(22) Filed: Apr. 27, 2010

(51) Int. Cl. H04N 7/18

(52) U.S. Cl. 348/159; 348/E07.091

(57) ABSTRACT

The present invention relates a system for displaying images. The system includes a user display for viewing images, a first sensor for capturing a first image and a second sensor for capturing a second image. A switch mounted on a hand grip of a weapon is toggled by the user to alternately display the first image and the second image.

### FIELD OF INVENTION

The present invention relates, in general, to remotely toggling between displayed images in night vision goggles. The system may include an enhanced night vision goggle (ENVG) mounted to a helmet of a soldier for providing a light intensified image. The system may also include a thermal weapon sight (TWS) mounted to the soldiers weapon for providing a thermal image. A thermal image captured by the TWS may be viewed through an eyepiece of the ENVG by remote activation. Displaying the TWS image in the ENVG may be accomplished by toggling a switch located on the forward hand guard or any other non-trigger position on the weapon. This allows the soldier to view the TWS image without removing his hand from the hand guard thereby maintaining firing position.

### BACKGROUND OF THE INVENTION

In conventional systems, a soldier may view a field of combat through a helmet mounted enhanced night vision goggle (ENVG) which displays a light intensified image. Mounted on the soldiers weapon may also be a thermal weapon sight (TWS) capable of capturing a thermal image. Viewing the TWS image through the eyepiece of the ENVG is conventionally accomplished by the soldier toggling a switch mounted on the TWS. In order to toggle the switch, however, the soldier must remove his hand from the forward hand grip of the weapon thereby increasing response time and leaving him vulnerable to attack.

### SUMMARY OF THE INVENTION

To meet this and other needs, and in view of its purposes, the present invention provides a system for alternately displaying images from a head mounted night vision goggle and video from a remote sensor such as a thermal weapon site mounted on a rifle. Control of the switching functions is accomplished while maintaining firing position on the rifle.

In one embodiment, the system includes a display for displaying images, a first sensor for capturing a first image, a second sensor for capturing a second image, and a switch mounted on a hand grip of a weapon. The display alternately displays the first image and the second image in response to the switch being toggled. In one embodiment, the display and the first sensor are mounted on goggles worn by a user holding the weapon, and the second sensor is mounted on the weapon. In another embodiment, the display and the first sensor are mounted on goggles worn by a user holding the weapon, and the second sensor is mounted at a location remote to the user.

The goggles may be enhanced night vision goggles, where the first sensor captures a light intensified image, and the second sensor captures a thermal image through a scope mounted on the weapon. The switch may be a push button that toggles between the first and second image when depressed by a user, where the push button is depressed by the user while holding the hand grip and firing the weapon. In one embodiment, the hand grip extends in a direction perpendicular to a barrel of the weapon (e.g. rifle). In another embodiment, the hand grip encircles the barrel of the weapon (e.g. rifle) and extends in a direction parallel and adjacent to the barrel.

In one embodiment, the system includes a display for displaying images, a receiver for receiving a first image, a sensor for capturing a second image, and a switch mounted on a hand grip of a weapon. The display alternately displays the first image and the second image in response to the switch being toggled. The display and the sensor are mounted on goggles worn by a user holding the weapon, and the receiver is mounted to the user or to the weapon. In one embodiment, the first image is an image captured by another sensor at a location remote from the user. In another embodiment, the first image is an image generated by a computer at a location remote from the user. Another sensor may be included for capturing a third image, and the switch may be a spring loaded rocker switch having three positions.

In general, the first image is displayed when the rocker switch is in a first position, the second image is displayed when the rocker switch is in a second position, and the third image is displayed when the rocker switch is in a third position. The switch is mounted on the hand grip such that a user can manipulate the switch while holding the hand grip.

In one embodiment, a method for displaying images includes toggling a switch mounted on a hand grip of a weapon, and alternately displaying a first image and a second image on a display in response to the switch being toggled. In general, the user holds the hand grip of the weapon while toggling the switch. The switch is activated by depressing a push button, and de-activated by releasing the push button. In general, the first image is displayed when the switch is activated, and the second image is displayed when the switch is de-activated.

In one embodiment, the first image captured by a sensor mounted on a helmet of a user is displayed when the switch is de-activated, and the second image captured by a sensor mounted on the weapon is displayed when the switch is activated. The switch is toggled when the hand grip is the forward grip of a rifle. In general, the switch is toggled by a forward hand of a user which supports a barrel of the rifle.

It is understood that the foregoing general description and the following detailed description are exemplary, but are not restrictive, of the invention.

### BRIEF DESCRIPTION OF THE FIGURES

FIG. 1a. is a view of a soldier holding a weapon including a switch located on the forward hand grip for remotely controlling night vision goggles to display an image captured by a thermal weapon sight, according to an embodiment of the present invention.

FIG. 1b. is a view of a soldier holding a weapon including a switch located on the forward hand grip for remotely controlling night vision goggles to display an image received by a receiver, according to an embodiment of the present invention.

FIG. 1c. is a view of a soldier holding a weapon including a switch located on the forward hand grip for remotely controlling night vision goggles to display an image captured by a thermal weapon sight or to display an image received by a receiver, according to an embodiment of the present invention.

FIG. 2. is a magnified view of the forward hand grip and switch in FIG. 1., according to an embodiment of the present invention.

FIG. 3. is a circuit including a switch configuration for remotely controlling the display of an image captured by a thermal weapon sight, according to an embodiment of the present invention.

FIG. 4. is a circuit including a three-way switch configuration for remotely controlling the display of an image captured by a thermal weapon sight, according to an embodiment of the present invention.

FIG. 5. is a circuit including a switch configuration for remotely controlling the display of an image captured by a thermal weapon sight or an image received by a receiver, according to an embodiment of the present invention.

### DETAILED DESCRIPTION OF THE INVENTION

As will be described, the present invention provides a system for toggling between displayed images while maintaining firing position. In one example, an enhanced night vision goggle (ENVG) mounted to the helmet of a soldier may be connected (e.g. by cable) to a thermal weapon sight (TWS) or an image receiver. The ENVG may include a light intensifier sensor for capturing a light intensified image, a display for displaying images (e.g. video) and an eyepiece allowing the soldier to view the images. The TWS located on a weapon may include a thermal (e.g. infrared) sensor and a magnifying scope for capturing a thermal image. The image receiver may wirelessly receive images from other sensors or computers remote from the soldier.

In general, the images captured by the sensors or received by the receiver may be displayed in the ENVG by toggling a switch located on the hand grip (i.e. forward hand guard) of a weapon (e.g. firearm such as a rifle). The location of the switch allows the soldier to toggle between displaying the images while maintaining a proper firing position (the soldier maintains his grip of the firearm). In general, the switch may be located on a hand grip or any other non-trigger position where the soldier holds the weapon when firing. Furthermore, the switch may be implemented as any type of mechanical switch (e.g. push button, rocker switch, toggles switch, etc. . . . ) or electronic switch (e.g. transistor, capacitive plate, optical sensor, etc. . . . ).

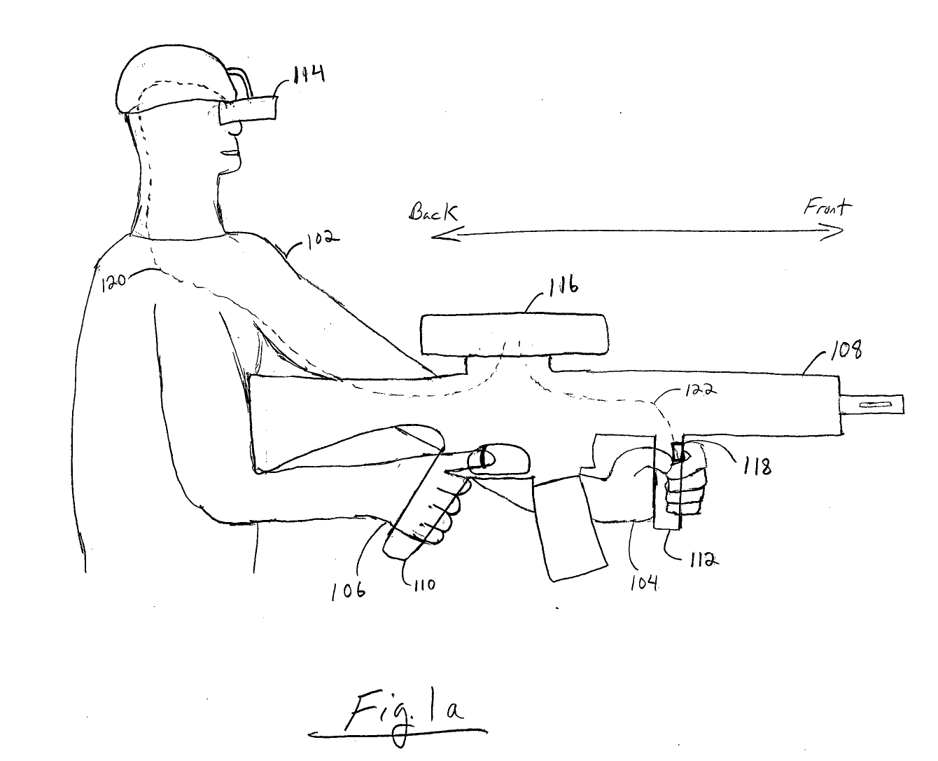

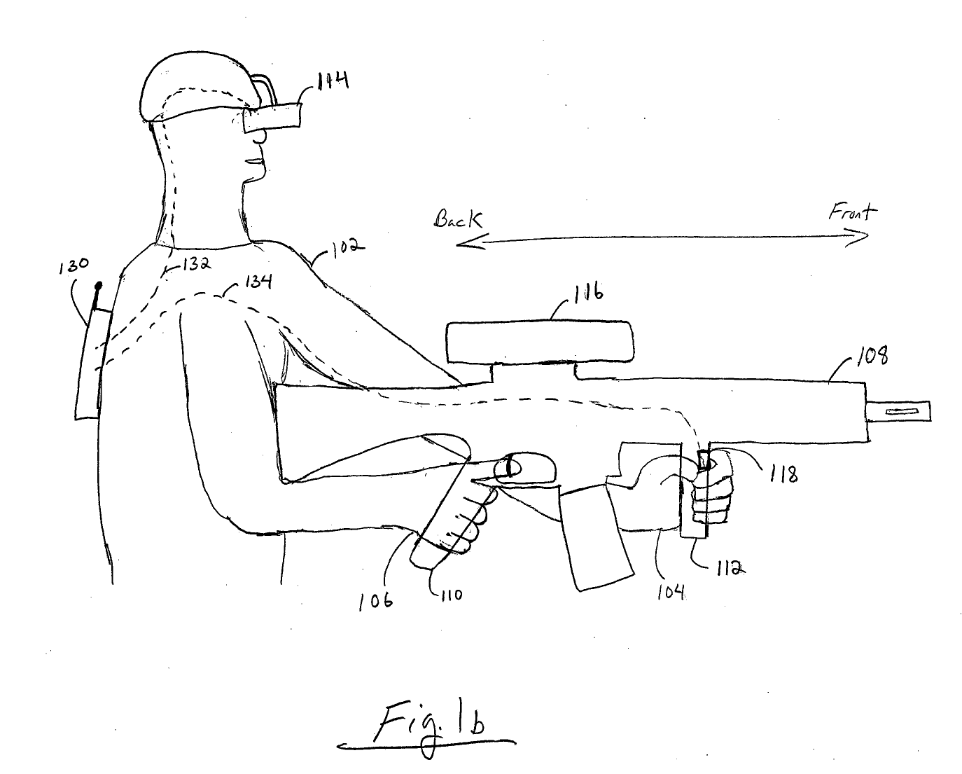

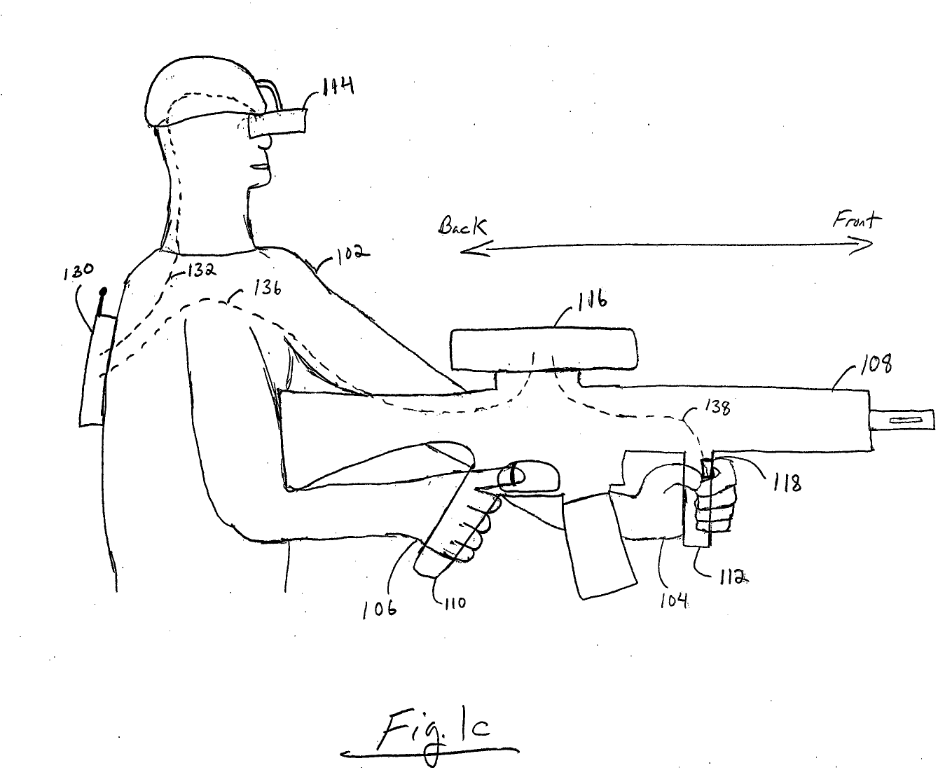

In one embodiment, FIG. 1a shows a side view of soldier 102 holding a weapon (e.g. rifle) 108 in a firing position. Mounted on the soldiers helmet is ENVG 114 which is connected to TWS 116 and remote switch 118 through cables 120 and 122. While in firing position, soldier 102 may hold weapon 108 with hand 106 on back hand grip 110 and hand 104 on forward hand grip 112 which provides positive control of weapon 108. In this example, hand grip 112 extends in a direction perpendicular to the barrel of the firearm. In another example, however, hand grip 112 may encircle the barrel of the firearm, and extend in a direction parallel to the barrel.

In general, switch 118 is provided in a location such that the soldier may toggle the switch without removing his hand 104 from forward hand grip 112 (e.g. switch may be mounted directly on the hand grip or at a location adjacent to the hand grip). In one example, switch 118 may be momentary push button that is activated when depressed by the soldiers finger (e.g. index finger) and de-activated when released by the soldiers finger.

In one embodiment, when switch 118 is activated, the thermal image captured by the sensor in TWS 116 may be displayed in place of the intensified image captured by the sensor in ENVG 114 (switch 118 is used to toggle between the images). In another embodiment, however, the thermal image captured by the sensor in TWS 116 may be fused together with the intensified image captured by sensor ENVG 114 or provided as a picture-in-picture. It should be noted that the sensors can be any type of sensors and are not limited to being thermal and image intensified sensors.

Displaying the images on in ENVG 114 may be accomplished in any number of ways. In one example, images captured by TWS 116 may be continuously provided to ENVG 114. In this example, an enable signal may be sent (in response to switch 118 being activated) through cables 120 and 122 instructing ENVG 114 to display the thermal images. In another example, images captured by TWS 116 may not be continuously provided to ENVG 114. In this example, the images are provided to ENVG 114 and displayed when switch 118 is activated.

Although FIG. 1a shows a configuration where ENVG 114 receives thermal images from TWS 116, it is also contemplated that ENVG 114 may receive other images from a source other than TWS 116. Shown in FIG. 1b is a configuration where switch 118 remotely activates the display of an image provided by receiver 130. In general, when switch 118 is activated, an enable signal may be sent through cables 132 and 134 instructing ENVG 114 to display an image received by receiver 130.

Image receiver 130 may be a device that wirelessly receives images from other sensors or computers at or near the battlefield. Some of the images that receiver 130 may receive include but are not limited to images from sensors mounted on other soldiers, images from sensors mounted throughout the battlefield, images from sensors mounted on vehicles and images/information from a computer database.

In one embodiment, receiver 130 may be receiving aerial images from an aircraft flying above the battlefield. During combat, soldier 102 may depress button 118 to display the received aerial image on ENVG 114 which may provide information pertaining to the soldiers surroundings such as his position relative to the enemy and landmarks on the battlefield.

In another embodiment, receiver 130 may be receiving computer generated maps. During combat, soldier 102 may activate switch 118 to display the received maps on ENVG 114. The maps may provide the soldier with navigation information such as images of roadways and topology.

FIG. 1c shows yet another embodiment which combines the systems in FIGS. 1a and 1b. Specifically, in FIG. 1c, ENVG 114 may receive images from either receiver 130 or TWS 116. In general, when switch 118 (which may be a spring loaded rocker switch with three positions) is toggled, an enable signal may be sent through cables 132, 136 and 138 instructing ENVG 114 to display the images received by receiver 130, display the images captured by the thermal sensor in TWS 116 or display the images captured by the image intensified sensor in ENVG 114.

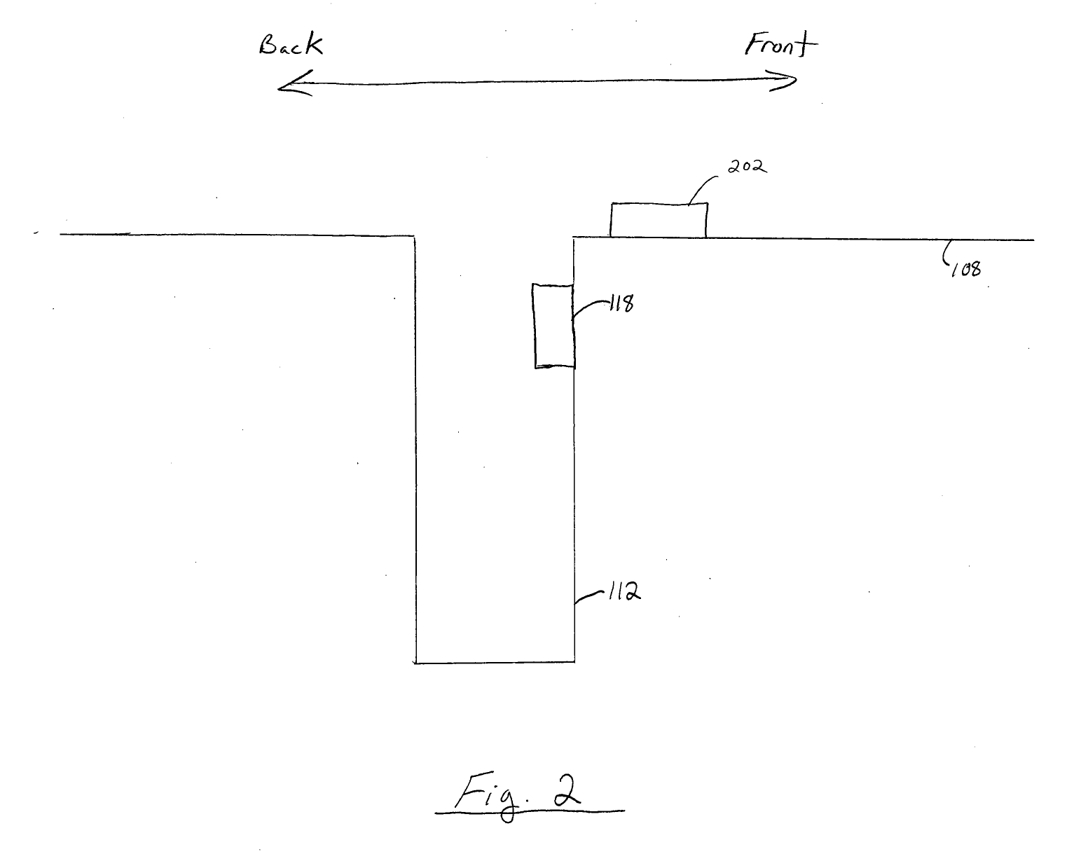

Shown in FIG. 2 is a magnified view of switch 118 mounted on front hand grip 112 of weapon 118. As previously described, the remote switch may be mounted directly on front hand grip 112 allowing button 118 to be depressed by the soldiers finger. In general, however, the remote switch can be mounted anywhere on front hand grip 112 or any adjacent location on weapon 108 which allows the soldier to maintain firing position while manipulating the switch (i.e the soldier does not have to remove his hand from the weapon to manipulate the switch).

For example, the remote switch may be mounted on the body of the weapon as button 202 in FIG. 2. This location allows the soldier to depress the button with his finger while still holding hand grip 112. The configuration of button 202 may also be used on a weapon that does not have hand grip extending perpendicular to the barrel (e.g. the hand grip may be encircling the barrel).

During combat, there may be situations where the soldier does not want to activate switch 118. Therefore, switch 118 may also include an optional protective guard (not shown) to prevent accidental activation. The guard may be a hinged plastic shield covering the button. In this example, when the soldier wants to manipulate switch 118, the shield may be flipped open (by the soldiers finger) exposing switch 118. This configuration allows the soldier to maintain his hand on the hand grip of the weapon while manipulating the protective guard.

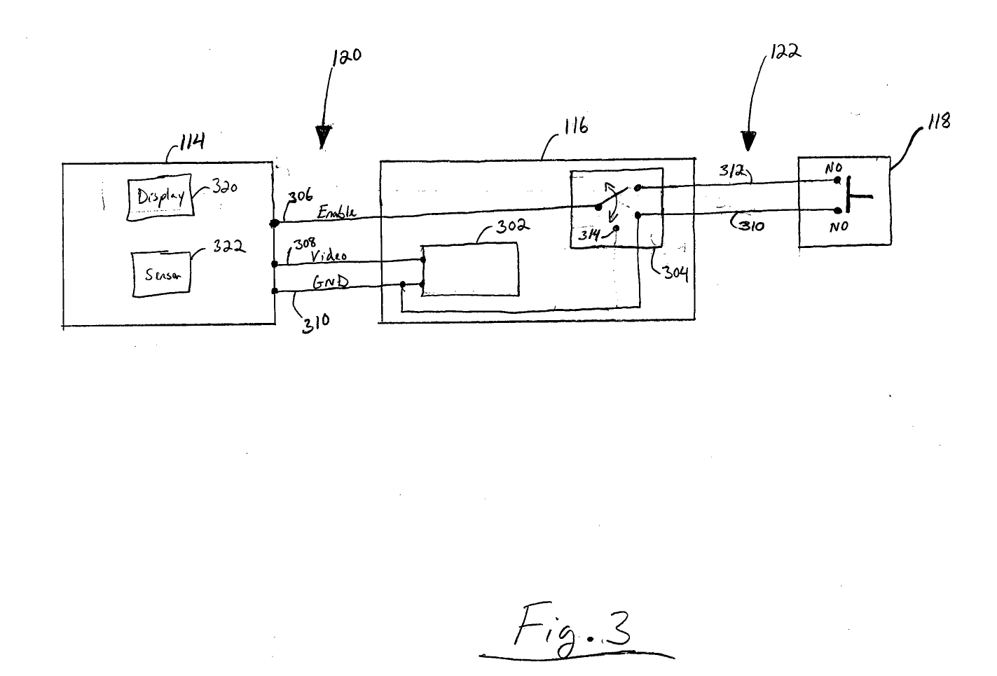

It is contemplated that various switch circuit configurations may be implemented to alternately display images in ENVG 114. FIGS. 3, 4 and 5 show three embodiments of such a circuit. Although three embodiments are described below, the system is not limited to the specific embodiments.

Shown in FIG. 3 is a circuit for remotely toggling between displaying the intensified image captured by the image intensified sensor in ENVG 114 or displaying the thermal image captured by the thermal sensor in TWS 116. In this embodiment, TWS 116 includes thermal sensor 302 for capturing and continuously outputting thermal images to ENVG 114, and a single pole triple throw switch 304. In this embodiment, switch 118 is implemented as a normally open momentary push button (e.g. the button closes when it is depressed).

In general, ENVG 114 is connected to TWS 116 via cable 120 which includes enable line 306, video line (e.g. RS-170) 308 and ground (GND) line 310. TWS is also connected to remote switch 118 via cable 122 which includes GND line 310 and enable line 312. In this embodiment, display 320 of ENVG 114 displays the thermal video captured by thermal sensor 302 when enable line 306 is connected to GND line 310 and displays the image intensified video captured by the image intensified sensor 322 in ENVG 114 when enable line 306 is not connected to GND line 310. In general, TWS 116 operates in three different switching modes corresponding to the three different throws of switch 304 (e.g. remote mode, manual ON mode and manual OFF mode).

In the first switching mode (remote mode), enable line 306 is connected to line 312 thereby allowing push button 118 to toggle between the image intensified video and the thermal video. When button 118 is momentarily depressed, enable line 306 is connected to GND line 310 which instructs ENVG 114 to display the thermal video. When button 118 is not depressed, however, enable line 306 is disconnected from GND line 310 thereby instructing ENVG 114 to display the image intensified video.

In the second switching mode (ON mode), line 306 is connected to line 310 thereby bypassing switch 118 and instructing ENVG 114 to display the thermal video. This mode may be useful when the soldier wants to display the thermal video if switch 118 is non-operational (e.g. switch 118 is broken).

In the third switching mode (OFF mode), line 306 is connected to floating node 314 thereby bypassing switch 118 and instructing ENVG 114 to display the image intensified video. This mode may be useful when the soldier wants to display the image intensified video if switch 118 is non-operational (e.g. switch 118 is broken).

It should be noted that the second and third switching modes are optional for bypassing switch 118. Bypassing switch 118 may be beneficial if switch 118 is broken and no longer operational. During combat situations, however, switch 304 should remain in the remote mode so that the soldier may use button 118 to toggle between the image intensified video and thermal video while maintaining firing position.

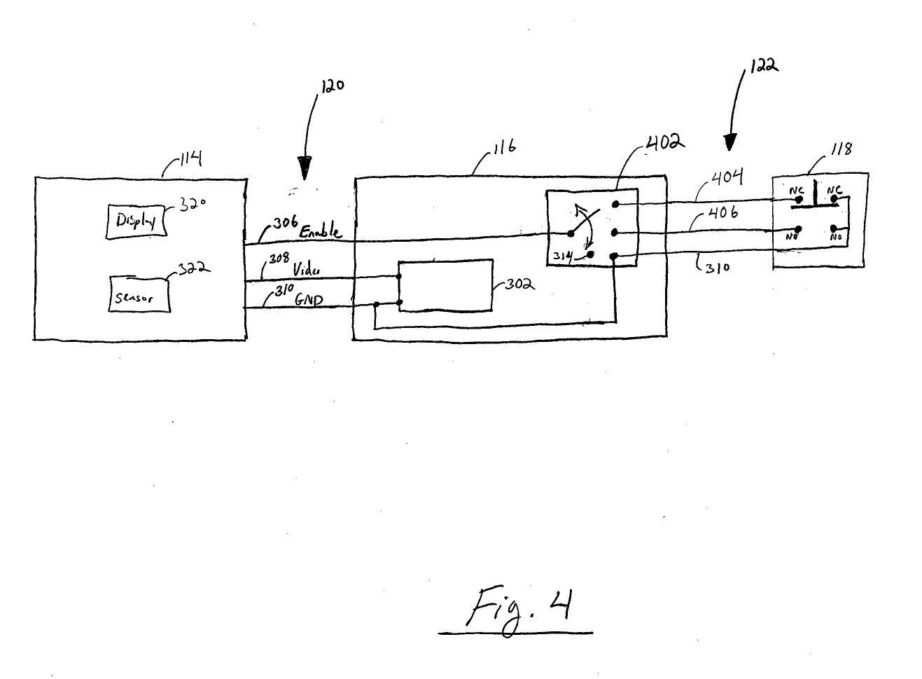

In FIG. 3, the remote switching mode is a normally open mode where push button 118 must be depressed to display the thermal video. It is contemplated, however, the soldier may benefit from a normally closed remote switching mode where the thermal video of TWS 116 are displayed when switch 118 is not being depressed. In FIG. 4, the remote switching mode is expanded into two sub-modes (e.g. normally off mode and normally on mode) by use of a three way switch setup.

In this embodiment, switch 402 includes a single pole quadruple throw switch. In general, TWS 116 operates in four different switching modes corresponding to the four different throws of switch 402 (e.g. normally off remote mode, normally on remote mode, manual ON mode and manual OFF mode).

In the first switching mode (normally off remote mode), line 306 is connected to line 406 and to the normally open contacts of push button 118. In this mode, when push button 118 is momentarily depressed, the thermal video of TWS 116 is displayed. When button 118 is not depressed, however, enable line 306 is disconnected from GND line 310 thereby disabling the thermal video and displaying the image intensified video. This mode is similar to the remote mode described in FIG. 3.

In the second switching mode (normally on remote mode), however, line 306 is connected to line 404 and GND line 310 through the normally closed contacts of push button 118. In this mode, when the push button 118 is not depressed, the thermal video of TWS 116 is displayed. When button 118 is momentarily depressed, however, enable line 306 is disconnected from GND line 310 thereby disabling the TWS video and displaying the image intensified video. The normally on remote mode (where pushing the button disables the TWS video) is effectively the opposite of the normally off remote mode (where pushing the button enables the TWS video). A benefit to the normally on remote mode is that the TWS video may be displayed for an extended period of time without having to continuously depress button 118.

The third and fourth switching modes in FIG. 4 are similar to the second (manual ON) and third (manual OFF) switching modes described above in reference to FIG. 3. As previously described, these modes are optional for bypassing switch 118 when determined beneficial (e.g. switch 118 is no longer operational).

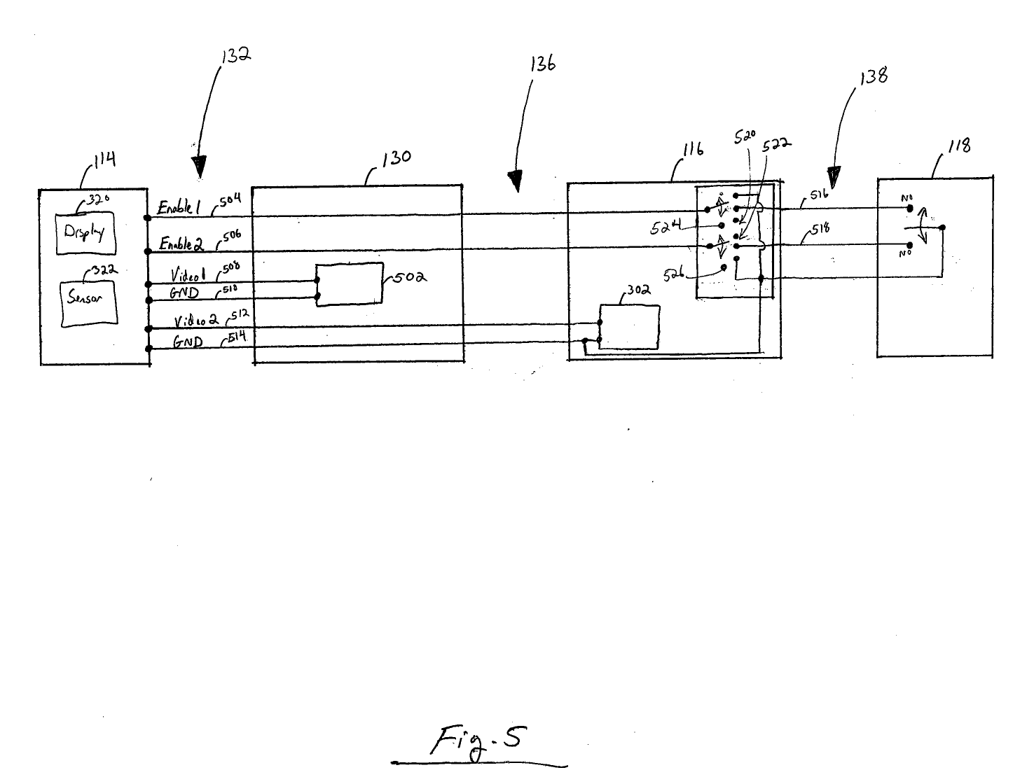

As previously described with reference to FIG. 1c, the soldier may want to have the option of displaying images (e.g. images received by receiver 130) other than the TWS video. Shown in FIG. 5 is a circuit for remotely enabling ENVG 114 to display video captured by TWS 116 or video/images received by receiver 130.

In this embodiment, ENVG 114 receives video from both video processor 502 in receiver 130 (through lines 508 and 510) and thermal sensor 302 in TWS 116 (through lines 512 and 514) of cable 132. This embodiment also includes two enable lines 504 and 506 for enabling the video from receiver 130 and the video from TWS 116 to be displayed respectively. In general, TWS 116 operates in four different switching modes corresponding to the four different throws of double pole quadruple throw switch 304 (e.g. remote mode, receiver video mode, TWS video mode and ENVG video mode).

In the first switching mode (remote mode), enable lines 504 and 506 are connected to lines 516 and 518 respectively thereby allowing rocker switch 118 to momentarily enable the light intensified video, receiver video or thermal video. When switch 118 is momentarily rocked in a first position, enable line 504 is connected to GND line 514 through line 516, which instructs ENVG 114 to display the video received by receiver 130. When switch 118 is momentarily rocked in a second position, enable line 506 is connected to GND line 514 through line 518, which instructs ENVG 114 to display the thermal video from TWS 116. When switch 118 is in a third (neutral resting) position, ENVG 114 displays the image intensified video captured by the image intensified sensor. The configuration in FIG. 5 allows the soldier to view heat radiating targets (e.g. humans) through TWS 116, view other data from other sensors or computers through receiver 130, and view image intensified images through ENVG 114 by toggling switch 118.

In the second switching mode (receiver video mode) enable line 504 is connected to GND while enable line 506 is connected to floating node 522 (receiver video is enabled while TWS video is disabled). In the third switching mode (TWS video mode) enable line 506 is connected to GND while enable line 504 is connected to floating node 520 (TWS video is enabled while receiver video is disabled). In the fourth switching mode (ENVG video mode) enable lines 504 and 506 are connected to respective floating nodes 524 and 526 (TWS video and receiver video are disabled) thereby displaying the image intensified video captured by sensor 322 in ENVG 114. The second, third and fourth optional modes in FIG. 5 bypass switch 118 and would be useful in situations where switch 118 is not functional.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A system for displaying images comprising:
a display for displaying images;
a first sensor for capturing a first image;
a second sensor for capturing a second image; and
a switch mounted on a hand grip of a weapon,
wherein the display alternately displays the first image and the second image in response to the switch being toggled.

2. The system of claim 1, wherein
the display and the first sensor are mounted on goggles worn by a user holding the weapon, and
the second sensor is mounted on the weapon.

3. The system of claim 1, wherein
the display and the first sensor are mounted on goggles worn by a user holding the weapon, and
the second sensor is mounted at a location remote to the user.

4. The system of claim 2, wherein
the goggles are enhanced night vision goggles,
the first sensor captures a light intensified image, and
the second sensor captures a thermal image through a scope mounted on the weapon.

5. The system of claim 1, wherein
the switch is a push button that toggles between the first and second image when depressed by a user, the push button being depressed by the user while holding the hand grip and firing the weapon.

6. The system of claim 1, wherein
the hand grip extends in a direction perpendicular to a barrel of the weapon, the weapon being a rifle.

7. The system of claim 1, wherein
the hand grip encircles a barrel of the weapon, the hand grip extending in a direction parallel and adjacent to the barrel, the weapon being a rifle.

8. A system for displaying images comprising:
a display for displaying images;
a receiver for receiving a first image;
a sensor for capturing a second image; and
a switch mounted on a hand grip of a weapon,
wherein the display alternately displays the first image and the second image in response to the switch being toggled.

9. The system of claim 8, wherein
the display and the sensor are mounted on goggles worn by a user holding the weapon, and
the receiver is mounted to the user or to the weapon.

10. The system of claim 9, wherein
the first image is an image captured by another sensor at a location remote from the user.

11. The system of claim 9, wherein
the first image is an image generated by a computer at a location remote from the user.

12. The system of claim 8, wherein
another sensor is included for capturing a third image, and
the switch is a spring loaded rocker switch having three positions.

13. The system of claim 9, wherein
the first image is displayed when the rocker switch is in a first position,
the second image is displayed when the rocker switch is in a second position, and
the third image is displayed when the rocker switch is in a third position.

14. The system of claim 8, wherein
the switch is mounted on the hand grip such that a user can manipulate the switch while holding the hand grip.

15. A method for displaying images comprising:
toggling a switch mounted on a hand grip of a weapon; and
alternately displaying a first image and a second image on a display in response to the switch being toggled.

16. The method of claim 15, including
holding, by a user, the hand grip of the weapon while toggling the switch.

17. The method of claim 16, including
activating the switch by depressing a push button; and
de-activating the switch by releasing the push button.

18. The method of claim 17, including
displaying the first image when the switch is activated; and
displaying the second image when the switch is de-activated.

19. The method of claim 17, including
displaying the first image captured by a sensor mounted on a helmet of a user when the switch is de-activated; and
displaying the second image captured by a sensor mounted on the weapon when the switch is activated.

20. The method of claim 15, including
toggling the switch when the hand grip is the forward grip of a rifle, the switch being toggled by a forward hand of a user which supports a barrel of the rifle.
